(19) United States
(12) Patent Application Publication
(10) Pub. No.: US 2012/0152279 A1
(43) Pub. Date: Jun. 21, 2012

(54) ELONGATED WASHCLOTH

(76) Inventor: Karen M.K. Clark, New Orleans, LA (US)

(21) Appl. No.: 13/327,698

(22) Filed: Dec. 15, 2011

Related U.S. Application Data
(60) Provisional application No. 61/423,853, filed on Dec. 16, 2010.

(51) Int. Cl. A47K 7/02; B08B 1/00

(52) U.S. Cl. 134/6; 15/210.1

(57) ABSTRACT

An elongated washcloth has one or more loops formed on each end thereof. The loops may be sized to fit a user's hands or wrists. The elongated washcloth may be formed from a single piece of material, where the loops are formed by folding the ends of a strip of material down onto itself. The elongated washcloth may be useful for people to clean themselves by rubbing a portion of the washcloth over sections of their body. The washcloth may be especially useful for people with limited range of motion, permitting such people to reach places they may otherwise be unable to reach with a conventional washcloth.

### CROSS-REFERENCE TO RELATED APPLICATIONS

The present application claims the benefit of priority of U.S. provisional patent application No. 61/423,853, filed Dec. 16, 2010, the contents of which are herein incorporated by reference.

### BACKGROUND OF THE INVENTION

The present invention relates to cleaning products and, more particularly, to a soft elongated washcloth that allows cleaning without bending or using full range of motion.

People that are overweight, recovering from surgery, have range of motion issues or are suffering from diabetes, do not have means of reaching certain areas of the body to clean with a conventional washcloth. Back scrubbers are often too harsh due to their exfoliating nature to use in such areas. Moreover, after surgery, or for other reasons, some people do not have the means to easily clean themselves after using the toilet.

As can be seen, there is a need for an apparatus that may permit personal hygiene in various people, including those with limited range of motion.

### SUMMARY OF THE INVENTION

In one aspect of the present invention, an elongated washcloth comprises a single piece of material having its ends folded onto itself to form one or more loops on each end thereof, wherein the elongated washcloth's length is from about 8 to about 30 times its width.

In another aspect of the present invention, a personal cleaning tool comprises an elongated washcloth including a single piece of material having its ends folded onto itself to form one or more loops on each end thereof, wherein the elongated washcloth's length is from about 8 to about 30 times its width; and a disposable liner removably attached to the elongated washcloth.

In a further aspect of the present invention, a method for cleaning hard to reach places on a person's body comprises grasping a loop disposed at each end of an elongated washcloth with each hand, the elongated washcloth including a single piece of material having its ends folded onto itself to form one or more of the loops on each end thereof, wherein the elongated washcloth's length is from about 8 to about 30 times its width; and passing the elongated washcloth along the person's body.

These and other features, aspects and advantages of the present invention will become better understood with reference to the following drawings, description and claims.

### BRIEF DESCRIPTION OF THE DRAWINGS

FIG. 1 is a perspective view of an elongated washcloth, in use, according to an exemplary embodiment of the present invention;

FIG. 2 is a perspective view of the elongated washcloth of FIG. 1, showing an alternative use;

FIG. 3 is a perspective view of the elongated washcloth of FIG. 1;

FIG. 4 is a cross-sectional view taken along line 4-4 of FIG. 3;

FIG. 5 is a perspective view of an elongated washcloth according to an alternate embodiment of the present invention;

FIG. 6 is a pictorial representation of folding an elongated washcloth for packaging in an individual use pack;

FIG. 7 is pictorial representation of a method for making the elongated washcloth of FIG. 1;

FIG. 8 is a pictorial representation of a method for making an elongated washcloth according to another exemplary embodiment of the present invention;

FIG. 9 is a perspective view of the elongated washcloth of FIG. 1 used with a disposable liner, according to an exemplary embodiment of the present invention; and

FIG. 10 is a cross-sectional view taken along line 10-10 of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an elongated washcloth having one or more loops formed on each end thereof. The loops may be sized to fit a user's hands. The elongated washcloth may be formed from a single piece of material, where the loops are formed by folding the ends of a strip of material down onto itself. The elongated washcloth may be useful for people to clean themselves by rubbing a portion of the washcloth over sections of their body. The washcloth may be especially useful for people with limited range of motion, permitting such people to reach places they may otherwise be unable to reach with a conventional washcloth.

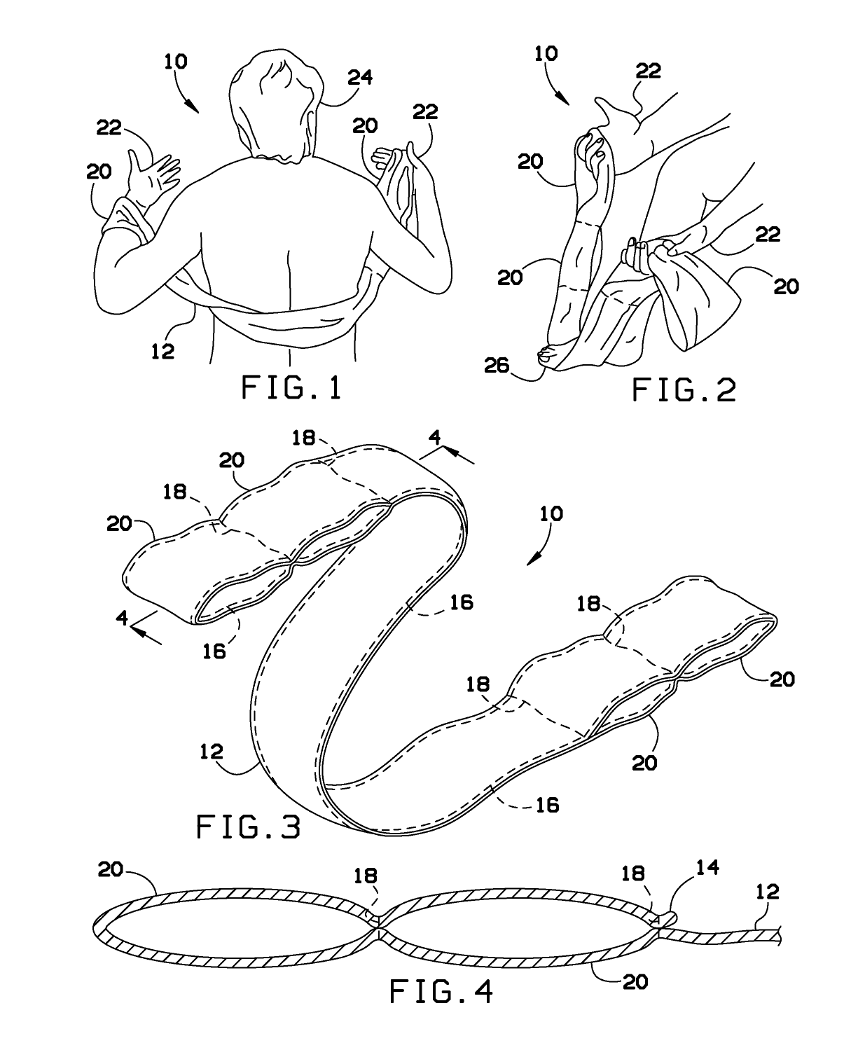

Referring now to FIGS. 1 through 4, an elongated washcloth 10 may include a body section 12 and one or more loops 20 formed on each end of the body section 12. The body section 12 and the loops 20 may be formed from a single piece of material that may be folded upon itself so that an end 14 of the material is disposed on a proximate (relative to the body section 12) end of the loops 20, as shown in FIG. 4, for example. The loops 20 may be formed by stitching 18. The side edges of the washcloth 10 may be finished in a variety of manners. For example, stitching 16, such as double stitched edging, may be applied along the edges of the washcloth 10.

The loops 20 may be designed to that hands 22 of a user 24 may fit into the loops 20, as shown in FIG. 2, to permit the user to wash the bottoms of their feet 26, for example. The loops 20 may also receive the wrists or lower arms of the user 24, as shown by the user's left hand in FIG. 1. Elastic (not shown) may be provided along the edges of the loops 20 to help secure the loops to the user's wrists, for example.

The washcloth 10 may be made from various materials. Typically, the washcloth 10 may be made from a soft, water absorbent material such as cotton, terry cloth, or the like. In some embodiments, a first material may be disposed on one side of the washcloth 10 and a second material may be disposed on the other side of the washcloth 10. For example, a soft material may be on one side of the washcloth 10 and an exfoliating material (coarser) may be on the other side of the washcloth 10. The washcloth 10 may be from about 2 to about 10 inches wide and from about 36 to about 90 inches long. Typically, the washcloth 10 may be about 72 inches long and about 5 inches wide. The washcloth's length may be from about 8 to about 30 times its width. The loops 20 may be from about 4 inches to about 8 inches in width, typically about 6 inches in width. Therefore, for two loops on each end, and a total length of 72 inches, a single piece of material that is at least 96 inches may be used. The washcloth 10 may include decorative edging, prints, monograms or the like.

While FIGS. 1 through 4 show two loops 20 on each end of the washcloth 10, additional loops may be added as appropriate. For example, 3 or 4 loops may be disposed on each end, providing the user with choices to determine the use length (that is, the length between the two chosen loops) of the washcloth 10.

Referring now to FIG. 5, a disposable washcloth multi-pack 28 may, for example, include six washcloths 58 disposed side by side, adjoined by perforations 30 so that the washcloths may be separated. The multi-pack 28 may be folded and provided in a roll, where a user may remove a disposable washcloth 58 from a roll and use accordingly. For example, such a configuration may be useful for use as flossing toilet paper. In other embodiments, perforations 30 may be formed on ends of disposable washcloths, and the disposable washcloths may be connected end to end. Stitching lines 32 show two loops 20 formed in the disposable washcloth multi-pack 28 of FIG. 5. Other numbers of loops 20 may be contemplated, as discussed above.

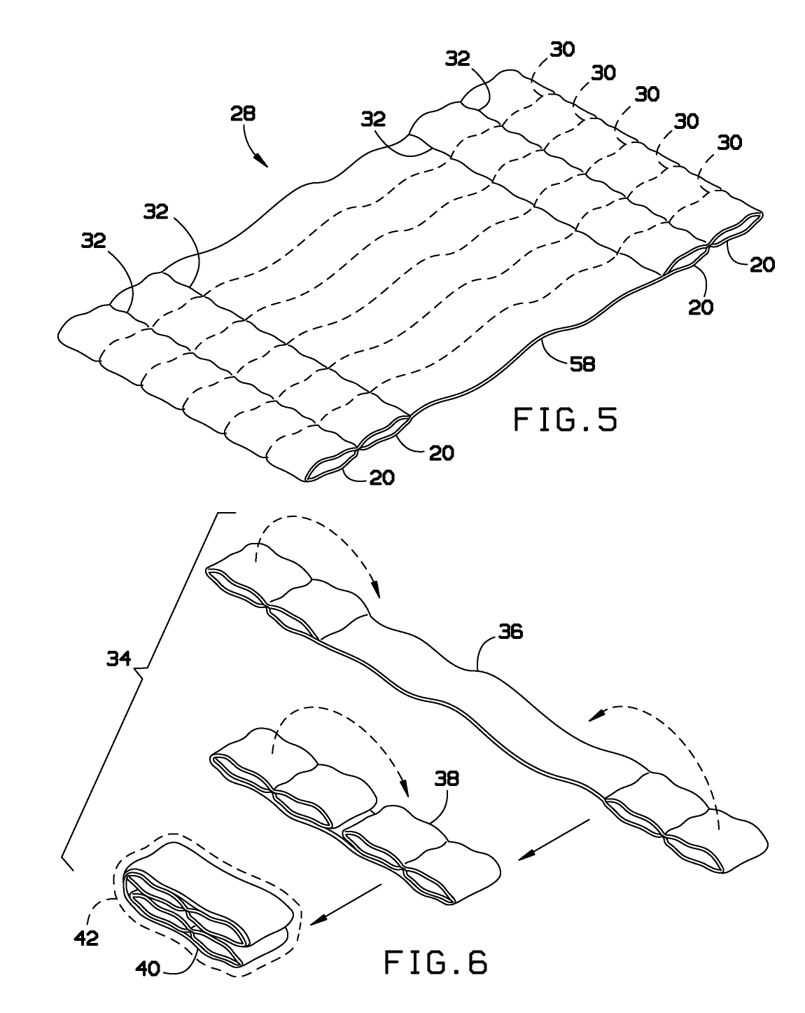

Referring to FIG. 6, a packet-disposed elongated washcloth 34 may be designed by folding an unfolded elongated washcloth 36 into a folded washcloth 40. The folded washcloth 40 may then be stored in a packet 42. In some embodiments, the packet 42 may be air tight to keep the washcloth 40 moist. In other embodiments, the packet 42 may be designed to protect a dry washcloth 40 stored therein. The washcloth 36 may be folded in other manners from that shown in FIG. 6 to fit into the packet 42.

Referring now to FIG. 7, a method for making a washcloth 44 is shown. The ends 14 of the single-piece material 12 may be folded onto itself and attached to itself at lines 50. Typically, the attachment will be stitching, however, other attachment methods, such as adhesive, may be used.

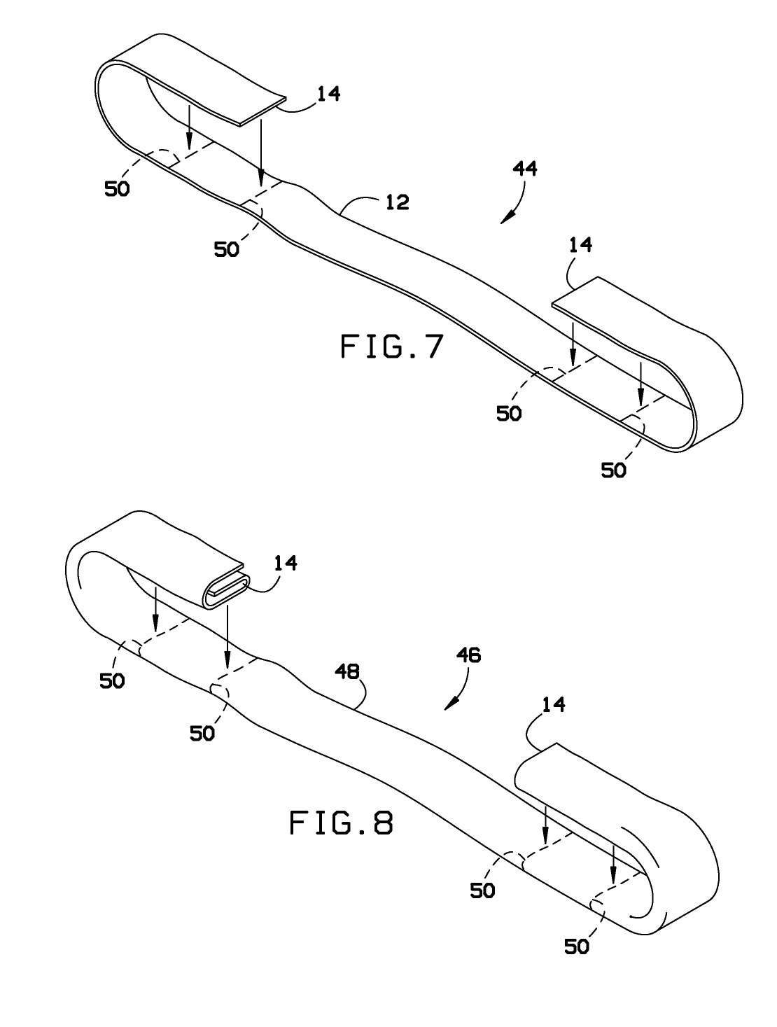

Referring now to FIG. 8, a method for making a tri-fold washcloth 46 is shown. There, the single-piece material 48 may be folded upon itself twice as can be seen at the ends 14 in FIG. 8. This configuration may form a reinforced washcloth that may resist the tendency to roll when being drawn across the body. The tri-fold washcloth 46 may be formed similar to the washcloths described above. The tri-fold design may include one or more unstitched portions along its edge to insert liquid or bar soap, for example.

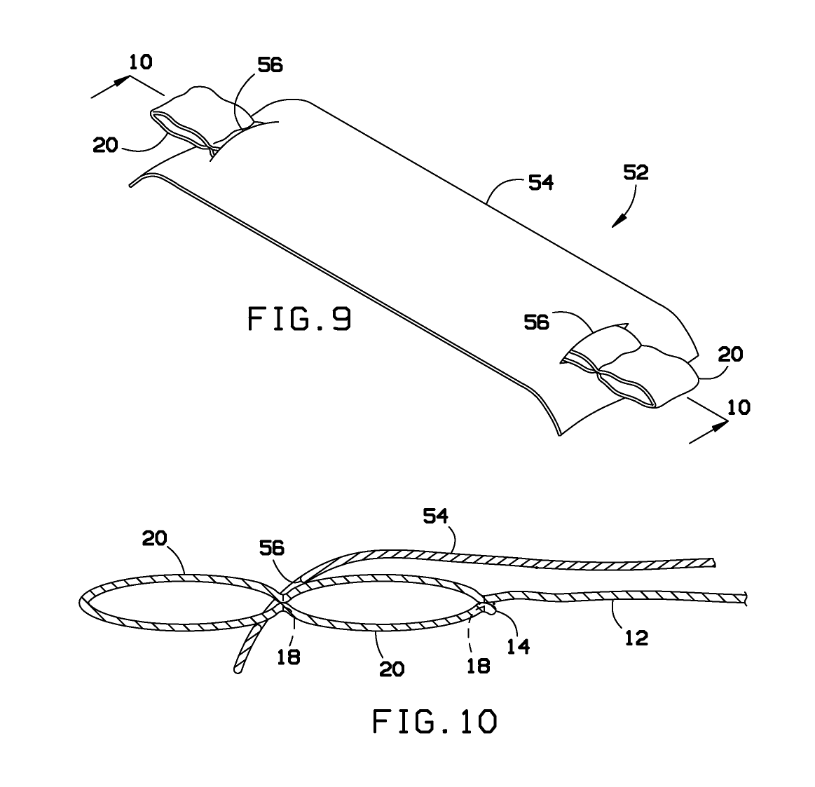

Referring now to FIGS. 9 and 10, the washcloth 10 may be used with a liner 54 to create a lined flossing tool 52. This device 52 may be used, for example, for cleaning oneself after using the toilet. The liner 54 may be disposable and may be discarded if soiled. The liner 52 may include slits 56 on each end thereof to secure the liner 54 to the washcloth 10. Other means may be used to secure the liner 52 to the washcloth 10, such as a loop and hook fastener, a pressure sensitive adhesive, or the like.

The washcloth of the present invention may be adapted for use in a variety of areas. For example, the washcloth may be used to clean large items or large animals by simply wrapping the washcloth around the item and using it in the same fashion as for use on a person, for example. The washcloth may also be used to help lift animals, such as large dogs. The washcloth may also be used to apply lotions or powders to the body or to dry a person.

It should be understood, of course, that the foregoing relates to exemplary embodiments of the invention and that modifications may be made without departing from the spirit and scope of the invention as set forth in the following claims.

What is claimed is:

1. An elongated washcloth comprising:
a single piece of material having its ends folded onto itself to form one or more loops on each end thereof, wherein the elongated washcloth's length is from about 8 to about 30 times its width.

2. The elongated washcloth of claim 1, wherein two or more loops are formed in each end.

3. The elongated washcloth of claim 1, wherein two loops are formed in each end.

4. The elongated washcloth of claim 1, wherein the single piece of material is disposable.

5. The elongated washcloth of claim 4, wherein a plurality of elongated washcloths are interconnected and separable at perforations.

6. The elongated washcloth of claim 1, further comprising a packet adapted to store a folded washcloth.

7. The elongated washcloth of claim 1, wherein the single piece of material is a tri-fold material.

8. A personal cleaning tool comprising:
an elongated washcloth including a single piece of material having its ends folded onto itself to form one or more loops on each end thereof, wherein the elongated washcloth's length is from about 8 to about 30 times its width; and
a disposable liner removably attached to the elongated washcloth.

9. The personal cleaning tool of claim 8, further comprising a slit on each end of the disposable liner, the slit adapted to receive ends of the elongated washcloth.

10. A method for cleaning hard to reach places on a person's body, the method comprising:
grasping a loop disposed at each end of an elongated washcloth with each hand, the elongated washcloth including a single piece of material having its ends folded onto itself to form one or more of the loops on each end thereof, wherein the elongated washcloth's length is from about 8 to about 30 times its width; and
passing the elongated washcloth along the person's body.

11. The method of claim 10, wherein two loops are formed in each end.
